(19) United States
(12) Patent Application Publication
(10) Pub. No.: US 2017/0220249 A1
(43) Pub. Date: Aug. 3, 2017

(54) Systems and Methods to Maintain Consistent High Availability and Performance in Storage Area Networks

(71) Applicant: NetApp, Inc., Sunnyvale, CA (US)

(72) Inventors: Mahmoud K. Jibbe, Wichita, KS (US); Jeff Hudson, Wichita, KS (US); Joseph Blount, Wichita, KS (US); Keith Holt, Wichita, KS (US)

(21) Appl. No.: 15/011,050

(22) Filed: Jan. 29, 2016

(51) Int. Cl. G06F 3/06; G06F 12/08

(52) U.S. Cl. CPC G06F 3/061; G06F 3/0689; G06F 3/0665; G06F 12/0806; G06F 3/065; G06F 2212/621

(57) ABSTRACT

Embodiments of the present disclosure enable high availability and performance in view of storage controller failure. A storage system includes three or more controllers that may be distributed in a plurality of enclosures. The controllers are in high availability pairs on a per volume basis, with volumes and corresponding mirror targets distributed throughout the storage system. When a controller fails, other controllers in the system detect the failure and assess whether one or more volumes and/or mirror targets are affected. If no volumes/mirror targets are affected, then write-back caching continues. If volume ownership is affected, then a new volume owner is selected so that write-back caching may continue. If mirror target ownership is affected, then a new mirror target is selected so that write-back caching may continue. As a result, write-back caching availability is increased to provide low latency and high throughput in degraded mode as in other modes.

### TECHNICAL FIELD

The present description relates to data storage systems, and more specifically, to a system configuration and technique for maintaining consistent high availability and performance in view of storage controller failure/lockdown/service mode/exception handling.

### BACKGROUND

While improvements to both hardware and software have continued to provide data storage solutions that are not only faster but more reliable, device failures have not been completely eliminated. For example, even though storage controllers and storage devices have become more resilient and durable, failures may still occur due to components connected to the controller such as drives, power supplies, fans, protocol links, etc. To guard against data loss, a storage system may include controller and/or storage redundancy so that, should one device fail, controller operation may continue and data may be recovered without impacting latency and input/output (I/O) rates. For example, storage systems may include storage controllers arranged in a high availability (HA) pair to protect against failure of one of the controllers.

For example, in a high availability storage system, two storage controllers may mirror copies of their caches to the other controller's cache in order to support write-back caching (to protect writes at a given controller while the data is still dirty, i.e. not committed to storage yet) and to avoid a single point of failure. In an example mirroring operation, a first storage controller in the high availability pair sends a mirroring write operation to its high availability partner before returning a status confirmation to the requesting host and performing a write operation to a first volume. Both controllers commit the data to non-volatile memory prior to returning status.

Though the above may guard against data loss, device failure in current high availability pairs still results in a loss of access and performance degradation. In failure situations, one of the controllers in the high availability pair becomes unavailable, removing the availability of write-back caching. Therefore, operations usually switch to other approaches, such as write-through (storing the data in cache and target volume at the same time before returning a status confirmation) that can have degraded performance from the perspective of the user (e.g., a host).

### BRIEF DESCRIPTION OF THE DRAWINGS

The present disclosure is best understood from the following detailed description when read with the accompanying figures.

FIG. 1 is an organizational diagram of an exemplary data storage architecture according to aspects of the present disclosure.

FIG. 2 is an organizational diagram of an exemplary architecture according to aspects of the present disclosure.

FIG. 3 is an organizational chart illustrating high availability scenarios according to aspects of the present disclosure.

FIG. 4A is an organizational chart illustrating high availability scenarios according to aspects of the present disclosure.

FIG. 4B is an organizational chart illustrating high availability scenarios according to aspects of the present disclosure.

FIG. 4C is an organizational chart illustrating high availability scenarios according to aspects of the present disclosure.

FIG. 5 is a flow diagram of a method for maintaining consistent high availability and performance in view of storage controller failure according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments. Finally, in view of this disclosure, particular features described in relation to one aspect or embodiment may be applied to other disclosed aspects or embodiments of the disclosure, even though not specifically shown in the drawings or described in the text.

Various embodiments include systems, methods, and machine-readable media for maintaining consistent high availability and performance in view of storage controller failure. According to embodiments of the present disclosure, a storage system may include a plurality of controllers, e.g. three or more, that may be distributed in a plurality of enclosures (e.g., two controllers per enclosure) that include multiple storage devices. The controllers may be configured in high availability pairs on a per volume basis, where the volumes and corresponding mirror targets are distributed throughout the storage system (also referred to as a cluster herein).

When a controller fails, the other controllers in the system may detect the failure and assess whether one or more volumes and/or mirror targets are affected (e.g., because the failed controller had ownership of one or both types). If no volumes or mirror targets are affected, then write-back caching (high availability access) may continue. If a volume ownership is affected, then in embodiments of the present disclosure a new volume owner is selected so that host access and write-back caching may continue. If a mirror target ownership is affected, then a new mirror target is selected so that write-back caching may continue. As a result of the configuration of embodiments of the present disclosure, write-back caching availability is increased to provide low latency and high throughput in degraded mode (e.g., a failed controller, a locked-down controller, a channel failure between controller and storage device enclosures, a path failure between a controller and a host, etc., which causes a RAID system to be in a degraded state) as in other modes.

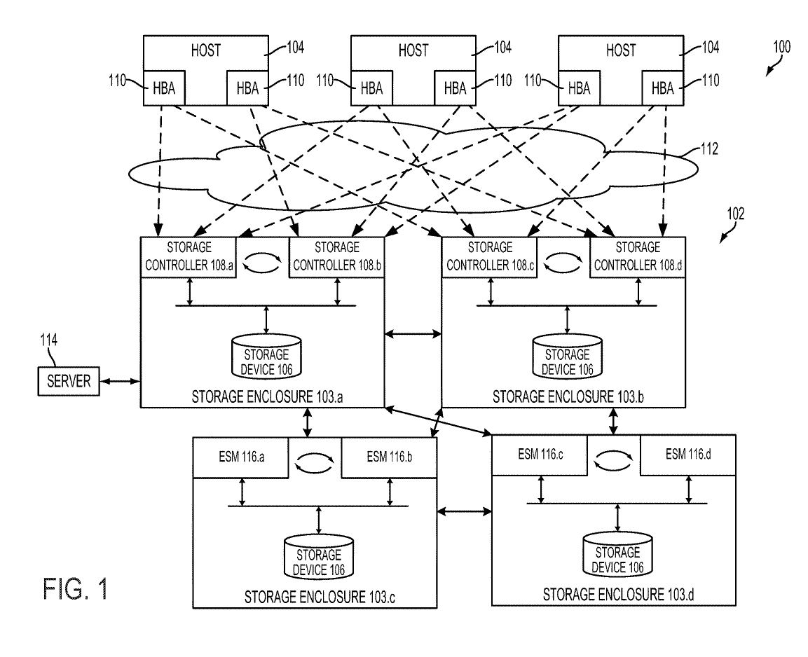

FIG. 1 illustrates a data storage architecture 100 in which various embodiments may be implemented. The storage architecture 100 includes a storage system 102 in communication with a number of hosts 104. The storage system 102 is a system that processes data transactions on behalf of other computing systems including one or more hosts, exemplified by the hosts 104. The storage system 102 may receive data transactions (e.g., requests to write and/or read data) from one or more of the hosts 104, and take an action such as reading, writing, or otherwise accessing the requested data. For many exemplary transactions, the storage system 102 returns a response such as requested data and/or a status indictor to the requesting host 104. It is understood that for clarity and ease of explanation, only a single storage system 102 is illustrated, although any number of hosts 104 may be in communication with any number of storage systems 102. According to embodiments of the present disclosure, the storage controllers 108 of the storage system 102 cooperate together to perform write-back caching. Further, when a storage controller 108 fails, at least one of the other storage controllers 108 selects a new volume owner and/or mirror target to continue providing write-back caching.

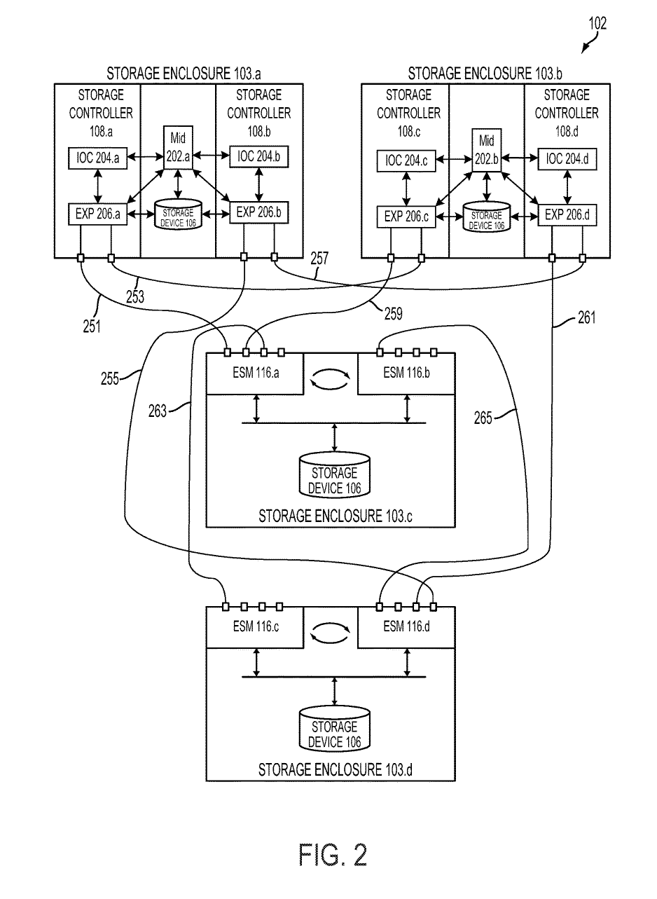

While the storage system 102 and each of the hosts 104 are referred to as singular entities, a storage system 102 or host 104 may include any number of computing devices and may range from a single computing system to a system cluster of any size. For example, as illustrated in FIG. 1 the storage system 102 includes four storage enclosures 103.a, 103.b, 103.c, and 103.d. More or fewer enclosures may be used instead of the four illustrated. For example, the firmware for the controllers 108 may be modified to enable more than two, e.g., four, storage controllers 108 to collaborate to provide high availability access and consistent performance for the storage system 102. The enclosures 103 are in communication with each other according one or more aspects illustrated and discussed with respect to FIG. 2 below.

The storage enclosure 103.a includes storage controllers 108.a and 108.b with one or more storage devices 106. The storage enclosure 103.b includes storage controllers 108.c and 108.d with one or more storage devices 106 as well. The storage enclosures 103.a and 103.b may both be RAID bunch of disks (RBOD), for example. The storage enclosure 103.c includes environmental services module (ESM) 116.a and ESM 116.b with one or more storage devices 106. Further, the storage enclosure 103.d includes ESM 116.c and ESM 116.d with one or more storage devices 106. The storage enclosures 103.c and 103.d may both be expansion bunch of disks (EBOD), for example. In this example, the ESMs 116 do not include the level of complexity/functionality of a storage controller, but are capable of routing input/output (I/O) to and from one or more storage devices 106 and to provide power and cooling functionality to the storage system 102. In alternative embodiments, the enclosures 103.c and/or 103.d may also have storage controllers instead of ESMs.

Accordingly, each storage system 102 and host 104 includes at least one computing system, which in turn includes a processor such as a microcontroller or a central processing unit (CPU) operable to perform various computing instructions. The instructions may, when read and executed by the processor, cause the processor to perform various operations described herein with the storage controllers 108.a, 108.b, 108.c, and 108.d in the storage system 102 in connection with embodiments of the present disclosure. Instructions may also be referred to as code. The terms “instructions” and “code” may include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The processor may be, for example, a microprocessor, a microprocessor core, a microcontroller, an application-specific integrated circuit (ASIC), etc. The computing system may also include a memory device such as random access memory (RAM); a non-transitory computer-readable storage medium such as a magnetic hard disk drive (HDD), a solid-state drive (SSD), or an optical memory (e.g., CD-ROM, DVD, BD); a video controller such as a graphics processing unit (GPU); a network interface such as an Ethernet interface, a wireless interface (e.g., IEEE 802.11 or other suitable standard), or any other suitable wired or wireless communication interface; and/or a user I/O interface coupled to one or more user I/O devices such as a keyboard, mouse, pointing device, or touchscreen.

With respect to the storage system 102, the exemplary storage system 102 contains any number of storage devices 106 spread in any number of configurations (e.g., 12 storage devices 106 in an enclosure 103 as just one example) between the enclosures 103.a-103.d and responds to one or more hosts 104's data transactions so that the storage devices 106 may appear to be directly connected (local) to the hosts 104. In various examples, the storage devices 106 include hard disk drives (HDDs), solid state drives (SSDs), optical drives, and/or any other suitable volatile or non-volatile data storage medium. In some embodiments, the storage devices 106 are relatively homogeneous (e.g., having the same manufacturer, model, and/or configuration). However, the storage system 102 may alternatively include a heterogeneous set of storage devices 106 that includes storage devices of different media types from different manufacturers with notably different performance.

The storage system 102 may group the storage devices 106 for speed and/or redundancy using a virtualization technique such as RAID or disk pooling (that may utilize a RAID level). The storage system 102 also includes one or more storage controllers 108.a, 108.b, 108.c, and 108.d (as well as ESMs 116.a-11.d) in communication with the storage devices 106 and any respective caches. The storage controllers 108.a, 108.b, 108.c, 108.d and ESMs 116.a-116.d exercise low-level control over the storage devices 106 (e.g., in their respective enclosures 103) in order to execute (perform) data transactions on behalf of one or more of the hosts 104. Having at least two storage controllers 108.a, 108.b may be useful, for example, for failover purposes in the event of equipment failure of either one. In particular, according to embodiments of the present disclosure having more than two storage controllers 108 may be useful for continuing to provide high availability and performance (e.g., because write-back caching remains supported even after a storage controller 108 failure). The storage system 102 may also be communicatively coupled to a user display for displaying diagnostic information, application output, and/or other suitable data.

In an embodiment, the storage system 102 may group the storage devices 106 using a dynamic disk pool (DDP) (or other declustered parity) virtualization technique. In a dynamic disk pool, volume data, protection information, and spare capacity are distributed across each of the storage devices included in the pool. As a result, each of the storage devices in the dynamic disk pool remain active, and spare capacity on any given storage device is available to the volumes existing in the dynamic disk pool. Each storage device in the disk pool is logically divided up into one or more data extents at various logical block addresses (LBAs) of the storage device. A data extent is assigned to a particular data stripe of a volume. An assigned data extent becomes a “data piece,” and each data stripe has a plurality of data pieces, for example sufficient for a desired amount of storage capacity for the volume and a desired amount of redundancy, e.g. RAID 0, RAID 1, RAID 10, RAID 5 or RAID 6 (to name some examples). As a result, each data stripe appears as a mini RAID volume, and each logical volume in the disk pool is typically composed of multiple data stripes.

In the present example, storage controllers 108.a and 108.b may be arranged as a first HA pair and the storage controllers 108.c and 108.d may be arranged as a second HA pair (at least initially). Thus, when storage controller 108.a performs a write operation for a host 104, storage controller 108.a may also sends a mirroring I/O operation to storage controller 108.b. Similarly, when storage controller 108.b performs a write operation, it may also send a mirroring I/O request to storage controller 108.a. Each of the storage controllers 108.a and 108.b has at least one processor executing logic to perform writing and migration techniques according to embodiments of the present disclosure.

Further, when storage controller 108.c performs a write operation for a host 104, storage controller 108.c may also sends a mirroring I/O operation to storage controller 108.d. Similarly, when storage controller 108.d performs a write operation, it may also send a mirroring I/O request to storage controller 108.c. Each of the storage controllers 108.c and 108.d has at least one processor executing logic to perform writing and migration techniques according to embodiments of the present disclosure.

As an alternative to the above, the HA pairs may be arranged such that both storage controllers 108 for a given HA pair are not located in the same enclosure 103. This may allow, for example, continued access to storage devices 106 when an entire enclosure 103 (e.g., due to a power failure where a given enclosure is connected) becomes unavailable. Thus, for example the storage controller 108.a in enclosure 103.a may be arranged in an HA pair with storage controller 108.c (or 108.d) in enclosure 103.b, and storage controller 108.b in enclosure 103.a may be arranged in an HA pair with storage controller 108.d (or 108.c) in enclosure 103.b.

The ESMs 116.a-116.d may also form HA pairs for access to the storage devices 106 in the enclosures 103.c and 103.d. For example, ESMs 116.a and 116.b may form an HA pair and ESMs 116.c and 116.d may form an HA pair. Similar to the alternative embodiment for the storage controllers 108.a-108.d, the ESMs 116.a-116.d may also be arranged so that HA pairs are not limited to the same enclosures 103.c, 103.d. Thus, ESM 116.a may be arranged in an HA pair with ESM 116.c (or 116.d) and ESM 116.b may be arranged in an HA pair with ESM 116.d (or 116.c).

The storage system 102 may also be communicatively coupled to a server 114. The server 114 includes at least one computing system, which in turn includes a processor, for example as discussed above. The computing system may also include a memory device such as one or more of those discussed above, a video controller, a network interface, and/or a user I/O interface coupled to one or more user I/O devices. The server 114 may include a general purpose computer or a special purpose computer and may be embodied, for instance, as a commodity server running a storage operating system. While the server 114 is referred to as a singular entity, the server 114 may include any number of computing devices and may range from a single computing system to a system cluster of any size. In an embodiment, the server 114 may also provide data transactions to the storage system 102, and in that sense may be referred to as a host 104 as well. The server 114 may have a management role and be used to configure various aspects of the storage system 102 as desired, for example under the direction and input of a user. Some configuration aspects may include definition of RAID group(s), disk pool(s), and volume(s), to name just a few examples. These configuration actions described with respect to server 114 may, alternatively, be carried out by any one or more of the other devices identified as hosts 104 in FIG. 1 without departing from the scope of the present disclosure.

With respect to the hosts 104, a host 104 includes any computing resource that is operable to exchange data with a storage system 102 by providing (initiating) data transactions to the storage system 102. In an exemplary embodiment, a host 104 includes a host bus adapter (HBA) 110 in communication with one or more storage controllers 108.a, 108.b, 108.c, 108.d of the storage system 102. The HBA 110 provides an interface for communicating with the storage controller 108.a, 108.b, 108.c, 108.d, and in that regard, may conform to any suitable hardware and/or software protocol. In various embodiments, the HBAs 110 include Serial Attached SCSI (SAS), iSCSI, InfiniBand, Fibre Channel, and/or Fibre Channel over Ethernet (FCoE) bus adapters. Other suitable protocols include SATA, eSATA, PATA, USB, and FireWire.

The HBAs 110 of the hosts 104 may be coupled to the storage system 102 by a network 112, for example a direct connection (e.g., a single wire or other point-to-point connection), a networked connection, or any combination thereof. Examples of suitable network architectures 112 include a Local Area Network (LAN), an Ethernet subnet, a PCI or PCIe subnet, a switched PCIe subnet, a Wide Area Network (WAN), a Metropolitan Area Network (MAN), the Internet, Fibre Channel, or the like. In many embodiments, a host 104 may have multiple communicative links with a single storage system 102 for redundancy. The multiple links may be provided by a single HBA 110 or multiple HBAs 110 within the hosts 104. In some embodiments, the multiple links operate in parallel to increase bandwidth.

To interact with (e.g., write, read, modify, etc.) remote data, a host HBA 110 sends one or more data transactions to the storage system 102. Data transactions are requests to write, read, or otherwise access data stored within a data storage device such as the storage system 102, and may contain fields that encode a command, data (e.g., information read or written by an application), metadata (e.g., information used by a storage system to store, retrieve, or otherwise manipulate the data such as a physical address, a logical address, a current location, data attributes, etc.), and/or any other relevant information. The storage system 102 executes the data transactions on behalf of the hosts 104 by writing, reading, or otherwise accessing data on the relevant storage devices 106. A storage system 102 may also execute data transactions based on applications running on the storage system 102 using the storage devices 106. For some data transactions, the storage system 102 formulates a response that may include requested data, status indicators, error messages, and/or other suitable data and provides the response to the provider of the transaction.

Data transactions are often categorized as either block-level or file-level. Block-level protocols designate data locations using an address within the aggregate of storage devices 106. Suitable addresses include physical addresses, which specify an exact location on a storage device, and virtual addresses, which remap the physical addresses so that a program can access an address space without concern for how it is distributed among underlying storage devices 106 of the aggregate. Exemplary block-level protocols include iSCSI, Fibre Channel, and Fibre Channel over Ethernet (FCoE). iSCSI is particularly well suited for embodiments where data transactions are received over a network that includes the Internet, a WAN, and/or a LAN. Fibre Channel and FCoE are well suited for embodiments where hosts 104 are coupled to the storage system 102 via a direct connection or via Fibre Channel switches. A Storage Attached Network (SAN) device is a type of storage system 102 that responds to block-level transactions.

In contrast to block-level protocols, file-level protocols specify data locations by a file name. A file name is an identifier within a file system that can be used to uniquely identify corresponding memory addresses. File-level protocols rely on the storage system 102 to translate the file name into respective memory addresses. Exemplary file-level protocols include SMB/CFIS, SAMBA, and NFS. A Network Attached Storage (NAS) device is a type of storage system that responds to file-level transactions. As another example, embodiments of the present disclosure may utilize object-based storage, where objects are instantiated that are used to manage data instead of as blocks or in file hierarchies. In such systems, objects are written to the storage system similar to a file system in that when an object is written, the object is an accessible entity. Such systems expose an interface that enables other systems to read and write named objects, that may vary in size, and handle low-level block allocation internally (e.g., by the storage controllers 108.a, 108.b). It is understood that the scope of present disclosure is not limited to either block-level or file-level protocols or object-based protocols, and in many embodiments, the storage system 102 is responsive to a number of different memory transaction protocols.

An exemplary storage system 102 is illustrated in more detail in FIG. 2, which is an organizational diagram of an exemplary architecture for a storage system 102 according to aspects of the present disclosure. As explained in more detail below, various embodiments include the storage controllers 108.a, 108.b, 108.c, and 108.d, and ESMS 116.a, 116.b, 116.c, and 116.d, executing computer readable code to perform operations described herein.

In particular, FIG. 2 illustrates the storage system 102 being configured with four enclosures 103.a-103.d as introduced in FIG. 1. FIG. 2, and this discussion, focuses on certain elements of the enclosures 103 for purposes of simplicity of discussion; each enclosure includes additional elements as will be recognized. Looking at enclosure 103.a as an example, the storage controller 108.a may include a storage input/output controller (IOC) 204.a (one is illustrated, though this may represent multiple). The IOC 204.a provides an interface for the storage controller 108.a to communicate with the storage devices 106 in the enclosure 103.a to write data and read data as requested. The IOC 204.a may conform to any suitable hardware and/or software protocol, for example including iSCSI, Fibre Channel, FCoE, SMB/CFIS, SAMBA, and NFS. The IOC 204.a is connected directly or indirectly to the midplane 202.a, as well as directly or indirectly to expander 206.a (e.g., a SAS expander). The expander 206.a may also be connected directly or indirectly to the midplane 202.a.

The storage controller 108.b in the enclosure 103.a also includes an IOC 204.b and expander 206.b, in communication with each other, the midplane 202.a, and storage devices 106 similar to as discussed above with respect to storage controller 108.a. Looking now at enclosure 103.b, the storage controller 108.c includes IOC 204.c and expander 206.c, in communication with each other, the midplane 202.b, and storage devices 106 of enclosure 103.b similar to as discussed above with respect to enclosure 103.a. Further, the storage controller 108.d includes IOC 204.d and expander 206.d, in communication with each other, the midplane 202.b, and storage devices 106 of enclosure 103.b similar to as discussed above.

The enclosures 103.c and 103.d may each be populated with ESMs 116, as discussed with respect to FIG. 1 above. The ESMs 116.a and 116.b in enclosure 103.c may be in communication with each other, and the storage devices 106 of enclosure 103.c, in similar manner as the storage controllers 108 of the other enclosures with midplanes, IOCs, and expanders, etc. The ESMs 116.c and 116.d in enclosure 103.d may be in communication with each other, and the storage devices 106 of enclosure 103.d, in similar manner as the storage controllers 108 of the other enclosures with midplanes, IOCs, and expanders, etc.

According to embodiments of the present disclosure, the storage system 102 clusters the storage enclosures 103 (as illustrated, enclosures 103.a, 103.b, 103.c, 103.d) to enable highly consistent performance and high availability access even during various types of failures, such as controller lockdowns, controller failures, firmware upgrades, and hardware upgrades (or, in other words, situations where a controller because unavailable). In an embodiment, the storage system 102 may cluster the enclosures 103 upon a discovery of the other enclosure (e.g., a backend discovery of the second enclosure 103 that is a RBOD). Further, as changes occur, such as a head swap, that may occur online (e.g., through accessing an expander backend through a failed controller 108).

For example, as illustrated in FIG. 2 each controller 108 and ESM 116 includes one or more ports (e.g., connected to respective expanders 206 in the controllers/ESMs). As illustrated, the storage controllers 108.a, 108.b, 108.c, and 108.d have two ports while the ESMs 116.a, 116.b, 116.c, and 116.d have four ports each. This is for illustration only; each may have more or fewer ports than those illustrated. The connections illustrated in FIG. 2 may be of any of a variety of types, such as Ethernet, fiber optic, etc.

The storage controller 108.a of enclosure 103.a is connected to the ESM 116.a of the enclosure 103.d via connection 251. Specifically, the connection 251 is between a first port connected to the expander 206.a of the storage controller 108.a and a first port of the ESM 116.a (e.g., connected to an expander of the ESM 116.a). The storage controller 108.a of enclosure 103.a is also connected to the storage controller 108.c of the enclosure 103.b via connection 253. Specifically, the connection 253 is between a second port connected to the expander 206.a of the storage controller 108.a and second port of the storage controller 108.c of the storage enclosure 103.b. A different order of the ports, and/or a different number of ports, may be alternatively used for connections 251 and 253.

The storage controller 108.b of enclosure 103.a is connected to the ESM 116.d of enclosure 103.d via connection 255. The connection 255 is between a first port connected to the expander 206.b of the storage controller 108.b and a fourth port of the ESM 116.c (e.g., connected to an expander of the ESM 116.c). The storage controller 108.b of the enclosure 103.a is also connected to the storage controller 108.d of the enclosure 103.b via connection 257. The connection 257 is between a second port connected to the expander 206.b of the storage controller 108.b and a second port connected to the expander 206.d of the storage controller 108.d of the storage enclosure 103.b. A different order of the ports, and/or a different number of ports, may be alternatively used for connections 255 and 257.

The storage controller 108.c of enclosure 103.b is connected to the ESM 116.a of the enclosure 103.c via connection 259. Specifically, the connection 259 is between a first port connected to the expander 206.c of the storage controller 108.c (in enclosure 103.b) and a second port of the ESM 116.a (e.g., connected to an expander of the ESM 116.a). The other port connected to the expander 206.c is the port with the connection 253 as noted above. A different order of the ports, and/or a different number of ports, may be alternatively used for connections 259 and 253 at the storage controller 108.c.

The storage controller 108.d of enclosure 103.b is connected to the ESM 116.d of the enclosure 103.d via connection 261. Specifically, the connection 261 is between a first port connected to the expander 206.d of the storage controller 108.d (in enclosure 103.b) and a first port of the ESM 116.d (e.g., connected to an expander of the ESM 116.d). The other port connected to the expander 206.d in the storage controller 108.d is the port with the connection 257 as noted above. A different order of the ports, and/or a different number of ports, may be alternatively used for connections 261 and 257 at the storage controller 108.d.

In addition to the above-noted connections, the ESM 116.a of enclosure 103.c may also be connected to the ESM 116.c of the enclosure 103.d via connection 263. The connection 263 may be between a third port of the ESM 116.a (e.g., connected to an expander of the ESM 116.a) and a first port of the ESM 116.c (e.g., connected to an expander of the ESM 116.c). The other ports of the ESM 116.a may be connected as noted above. A different order of the ports, and/or a different number of ports, may be alternatively used for connections 251, 259, and 263 at the ESM 116.a.

Also in addition, the ESM 116.b of enclosure 103.c may be connected to the ESM 116.d of the enclosure 103.d via connection 265. The connection 265 may be between a first port of the ESM 116.b (e.g., connected to an expander of the ESM 116.b) and a first port of the ESM 116.d (e.g., connected to an expander of the ESM 116.d). Other ports than the first one may be used for connection 265 as well.

Several different benefits arise from configuring and connecting the cluster in the storage system 102 as described above and illustrated in FIG. 2. For example, with the “top-down, bottom-up” approach illustrated here, even if the storage enclosure 103.c becomes wholly unavailable (e.g., due to both ESMs 116.a, 116.b failing or power being cut to the whole enclosure, etc.), one or more of the storage controllers 108.a, 108.b, 108.c, and 108.d may be able to still access data stored at the storage devices 106 in the enclosure 103.d (as opposed to when the enclosures are daisy-chained). This may be done, for example, with a host request sent directly to either the storage controller 108.b, with access via connection 255 to ESM 116.c of enclosure 103.d, or the storage controller 108.d, with access via connection 261 to ESM 116.d of enclosure 103.d.

Access may also be available using I/O shipping between controllers 108. For example, where volume ownership for a volume at one or more storage devices 106 housed at enclosure 103.d is by storage controller 108.d (the preferred path is via storage controller 108.d as determined by LUN balancing, for example), and an I/O request comes from a host 104 to storage controller 108.a, the I/O may be processed with I/O shipping via the connection 257 to the storage controller 108.d for access to the desired locations in one or more storage devices 106 at enclosure 103.d. For example, when I/O (or other command) is received at a non-preferred controller 108, the non-preferred controller 108 sends the command on to the preferred controller 108 via one or more connections between controllers (e.g. 253, 257 and/or midplane 202), where the data is written to the preferred memory (or accessed therefrom) by the preferred controller 108, and then the data (or confirmation) is sent back to the non-preferred controller 108 by the one or more connections for confirmation/return to the requesting host 104.

Over time, if the storage system 102 observes that the preferred path over storage controller 108.d is less frequently used than a non-preferred path, the storage controller 108.d, for example (or the more-used storage controller 108 for example), may determine that a new preferred path should be selected. In this example, the storage controller 108.d may select the new preferred path or, alternatively, may allow the more-utilized path (the more utilized storage controller 108 receiving the I/O from one or more hosts 104) to claim ownership as a preferred path.

In addition to the benefits noted above for the top-down, bottom up approach illustrated, a database may keep track of various elements of configuration information for the volumes as well as other information such as error logs and operating system images. Each of the storage controllers 108 may cooperate in maintaining and updating the database during operation, and/or may be managed by a user at server 114 (to name an example). According to embodiments of the present disclosure, this database may be limited to being stored on a fixed number of storage devices 106 per enclosure 103 (e.g., 3 storage devices 106 per enclosure 103 as just one example). Limiting the database storage to a fixed number of storage devices 106 may also limit the amount of overhead that comes with adding more storage devices 106 (since the database is not spread to those devices as well). Further, with the database in place a master transaction lock may be applied when any of the four storage controllers 108 (or more or fewer, where applicable) access/update/etc. the database. As a result, when a first controller 108 is making one or more configuration changes in the database, it acquires during this time the master transaction lock which locks other controllers 108 in the storage system 102 from also attempting to make any changes to the database. Thus, according to embodiments of the present disclosure the master transaction lock is spread to all of the storage controllers 108 in the storage system 102.

According to embodiments of the present disclosure, when a storage controller 108 becomes unresponsive (e.g., due to failure), at least one of the other storage controllers 108 detects this change and reassigns volumes and/or mirror targets (to volumes owned by other storage controllers 108 in the storage system 102) owned by the unresponsive storage controller 108 to other storage controllers 108 in the storage system 102. When at least one of the operating storage controllers 108 detects an unresponsive storage controller 108 , embodiments of the present disclosure allow the other storage controllers 108 to isolate the unresponsive storage controller 108 (e.g., engage in “fencing”). This may last through ownership transfer and afterwards, for example until the unresponsive storage controller 108 is replaced and/or brought back online.

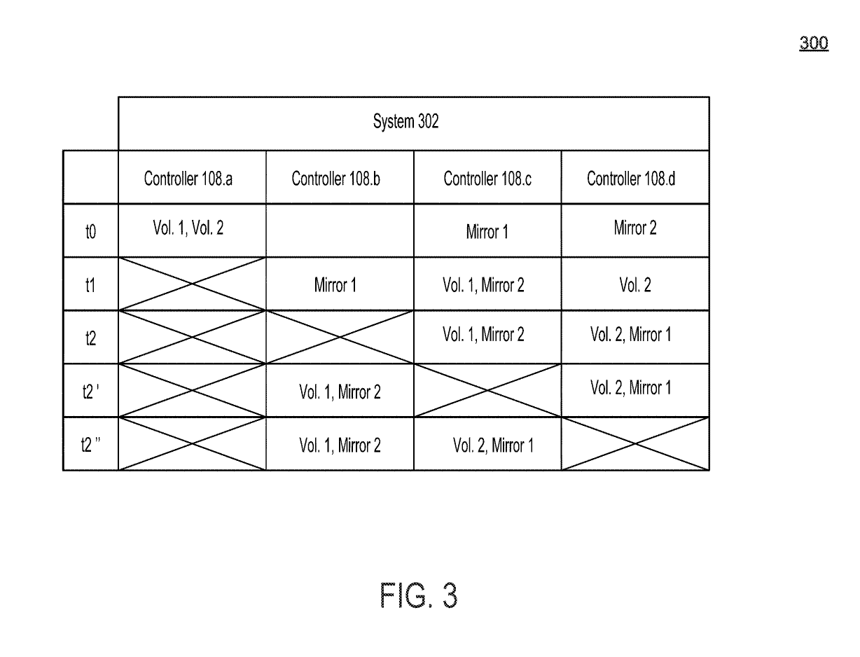

FIG. 3 is an organizational chart 300 illustrating high availability scenarios according to aspects of the present disclosure. This is illustrated with respect to a system 302, which may be an example of storage system 102 of FIGS. 1 and 2 above. Different scenarios of what may happen with the storage controllers 108.a, 108.b, 108.c, and 108.d are illustrated according to embodiments of the present disclosure. For simplicity of discussion, any event that could render a storage controller 108 unresponsive will be referred to as a “failure” of that storage controller 108.

As illustrated in FIG. 3, at time t0, an initial time, all of the storage controllers 108 are in operation. In the example of FIG. 3, there are two different volumes, 1 and 2, with corresponding mirror targets (1 and 2, respectively) for ease of illustration. Any number of volumes may be maintained by the storage system 102 of which chart 300 is exemplary. According to embodiments of the present disclosure, the mirror targets 1 and 2 (also referred to herein as mirror partners) are on a per-volume basis instead of a per-controller basis. Thus, different storage controllers 108 may be associated as mirror targets to different volumes, even where the different volumes are owned by the same storage controller 108. Further, when a storage controller 108 becomes unresponsive (e.g., failure), any volumes and mirrors impacted by that (e.g., were owned by the now-failed storage controller 108) are distributed across some or all of the surviving storage controllers 108 in the system 102 (and, thereby, contributing to recovery efforts such as selecting new volume owners, mirrors, copying mirrored data, etc.).

As illustrated in FIG. 3, storage controller 108.a has ownership of the two volumes, 1 and 2. At some previous time when the storage controller 108.a became the owner of these two volumes 1 and 2, the storage controller 108.a also selected one or more other storage controllers 108 to be owners of the mirror targets 1 and 2. In this example, the storage controller 108.a selected storage controller 108.c as owner for the mirror target 1, corresponding to the volume 1, and storage controller 108.d as owner for the mirror target 2, corresponding to the volume 2. This selection may have been made based on an awareness of the number of volumes and/or mirror targets currently owned by any given storage controller 108. In response to this selection, the storage controller 108.a communicates the ownership responsibility to the selected controllers, here storage controller 108.c and storage controller 108.d.

In an embodiment, the storage controller 108.a, when selecting mirror target owners from the other storage controllers 108, may additionally (to load/ownership balancing), may take into consideration what storage enclosure(s) 103 the candidate storage controllers 108 are located. Thus, in the example of FIG. 3, the storage controller 108.a is aware that it is located in the storage enclosure 103.a (as illustrated in FIGS. 1 and 2) and may determine to select another storage controller(s) 108 that is located in a different enclosure 103. Here, that would result in selecting one or both of storage controllers 108.c and 108.d that are located in the separate enclosure 103.b. In an embodiment, this may take precedence over other distribution considerations at the initial setup stage (where mirror targets are initially selected). In an alternative embodiment, distribution considerations may take precedence over this enclosure consideration at the initial setup stage.

At time t1, as illustrated, the storage controller 108.a fails. As a result, the volumes 1 and 2 are no longer accessible for I/O requests from one or more hosts. At the time of the failure, write-back caching may become temporarily unavailable until high-availability can be re-established between storage controller pairs. In response to detecting this failure, for example in response to the storage controllers 108.c and 108.d (which both own mirror targets impacted) detecting this failure of storage controller 108.a, convert their mirror targets to be the volumes. This may include, for example, updating metadata indicating that what was previously the mirror target is now the volume (e.g., locally and/or in the database discussed above). Thus, storage controller 108.c, which previously owned mirror target 1, converts mirror target 1 to be volume 1 and storage controller 108.d, which previously owned mirror target 2, converts mirror target 2 to be volume 2.

With the change, the storage controller 108.c, as the new owner of volume 1, selects a storage controller 108 to be owner of the new mirror target 1. In the example of FIG. 3, the storage controller 108.c selects storage controller 108.b to be owner of the mirror target 1, for example so that the mirror target remains with a different enclosure (and/or based on distributing the balance of ownership among the remaining storage controllers 108). With this selection, the storage controller 108.c copies the contents of its cache for mirror target 1 and provides that to the storage controller 108.b to recreate the mirror target 1 there.

Further, still at time t1, the storage controller 108.d, as the new owner of volume 2, selects a storage controller 108 to be owner of the new mirror target 2. In the example of FIG. 3, the storage controller 108.d selects the storage controller 108.c as the new owner of the mirror target 2. As can be seen, this results in the two owners being associated with the same enclosure for this example. The storage controller 108.d copies the contents of its cache for mirror target 2 and provides that to the storage controller 108.c to recreate the mirror target there. Once the selections and transfers are complete, write-back caching may resume and, as a result, high availability and high performance is more quickly restored than is currently the case (sometimes imperceptible to users/hosts 104).

At time t2, a second failure occurs, this time at storage controller 108.b. Since there are four storage controllers 108 in this example, high availability through write-back caching is still available between storage controllers 108.c and 108.d. Since the storage controller 108.b awas owner of the mirror target 1 at time t2, the storage controller 108.c (as owner of volume 1) selects a new storage controller 108 for ownership of the mirror target 1. As only two controllers are now available, the storage controller 108.c selects storage controller 108.d as the new owner for mirror target 1. With this selection, the storage controller 108.c copies the contents of its cache for volume 1 and provides that to the storage controller 108.d to recreate the mirror target 1 there. Write-back caching resumes as soon as the information is copied to the storage controller 108.d.

FIG. 3 explores several different alternatives to the failure identified at time t2, illustrated as alternative times t2′ and t2″. At time t2′, instead of storage controller 108.b failing, the storage controller 108.c fails (where volume 1 and mirror target 2 are currently owned). As a result, write-back caching may become unavailable until a transition occurs. Here, since the failed storage controller 108.c was owner of volume 1, the owner of mirror target 1 (storage controller 108.b) may become owner of the volume 1. As a result, the storage controller 108.b may select a new owner for mirror target 1. Since storage controller 108.d is the only other one available now in this storage system 102, the storage controller 108.d selects it for mirror target 1. Storage controller 108.b copies its cache for volume 1 and provides that to the storage controller 108.d to recreate the mirror target 1 there. Write-back caching for volume 1 resumes as soon as the information is copied to the storage controller 108.d.

Further, still at time t2′, the storage controller 108.d, as owner of volume 2, must select a new owner for the mirror target 2. Since only the storage controller 108.b is the other available storage controller, it is selected to own mirror target 2. The storage controller 108.d copies its cache for volume 2 and provides that to the storage controller 108.b to recreate the mirror target 2 there. Write-back caching for volume 2 resumes as soon as the information is copied to the storage controller 108.b.

At time t2″, instead of storage controller 108.c failing, storage controller 108.d fails (where volume 2 is currently owned from time t1). As a result, write-back caching may become unavailable until a transition occurs. Here, since the failed storage controller 108.d was owner of volume 2, the owner of mirror target 2 (storage controller 108.c) may become owner of the volume 2. As a result, the storage controller 108.c may select a new owner for mirror target 2. Since storage controller 108.b is the only other one available now in this storage system 102, the storage controller 108.c selects it for mirror target 2. Storage controller 108.c copies its cache for volume 2 and provides that to the storage controller 108.b to recreate the mirror target 2 there. Write-back caching for volume 2 resumes as soon as the information is copied to the storage controller 108.b.

Further, still at time t2″, it is indicated in FIG. 3 that storage controller 108.c ceases to be the owner of volume 1, instead becoming the mirror target for volume 1. Likewise, storage controller 108.b ceases to be the mirror target for volume 1, instead becoming the owner of volume 1. Since neither storage controller 108.c nor 108.b were failed at time t2″, this transition may not be necessary for the purpose of maintaining minoring operations. However, for the purpose of maintaining consistent performance and even distribution of overhead, transitioning the ownership of volume 1 from 108.c to 108.b may be appropriate.

In the above examples, if high availability for volume 1 or 2 is not affected by a storage controller 108 failure, then write-back caching may remain available for that volume. Thus, at t2, write-back caching may remain for volume 2 while volume 1 is taken care of, and at t2″ write-back caching may remain for volume 1 while volume 2 is taken care of.

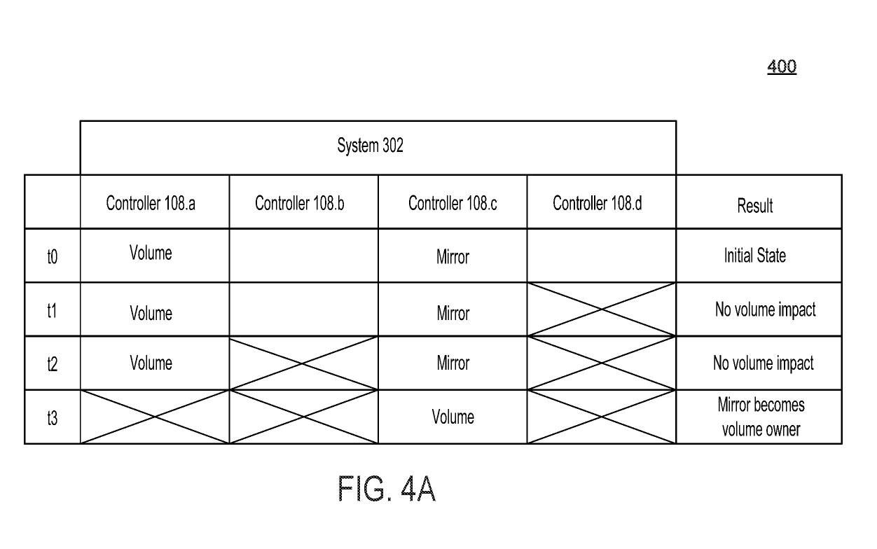

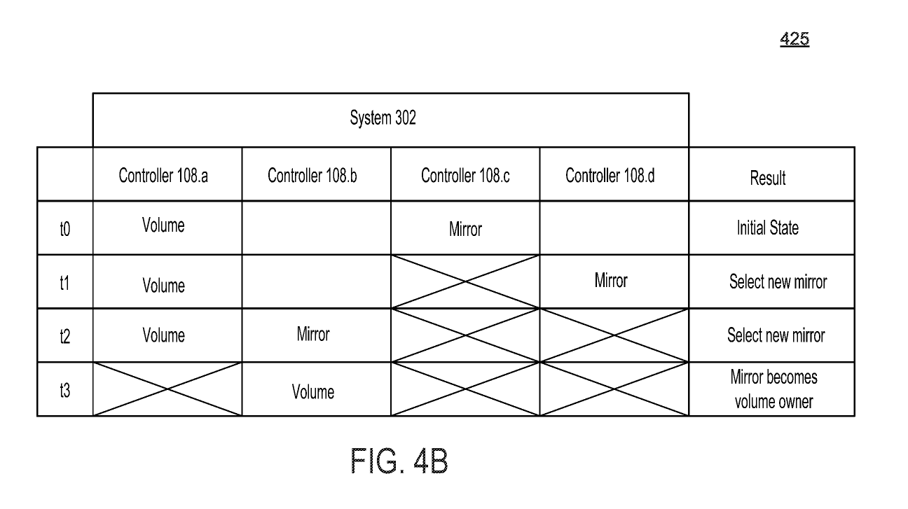

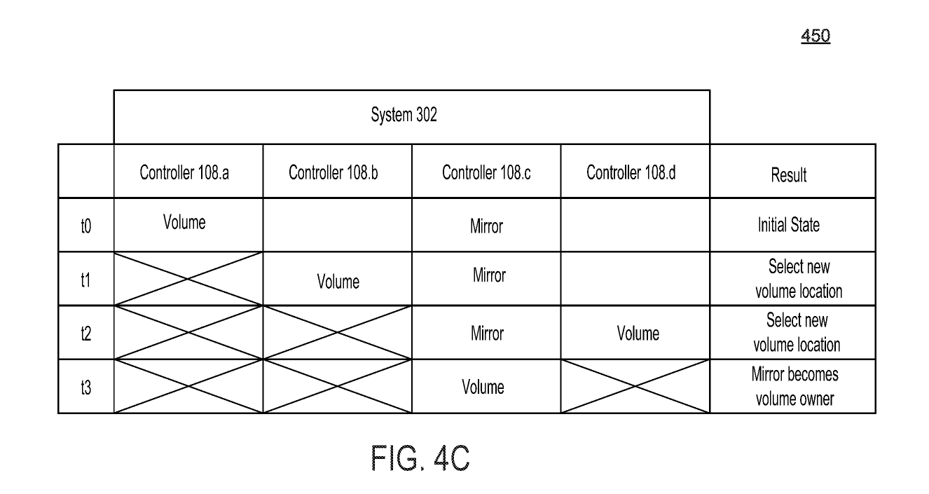

Turning now to FIG. 4A, an organizational chart 400 illustrates high availability scenarios according to aspects of the present disclosure dealing with non-impactful failures. A non-impactful failure may refer to storage controller 108 failure(s) that do not impact high availability for any given volume (e.g., there is not a volume or a minor target ownership at the failed controller). The organizational chart 400 continues with the exemplary system 302 with storage controllers 108.a, 108.b, 108.c, and 108.d.

Time t0 illustrates the initial state of high availability for a single volume (for simplicity of discussion/illustration). As shown, storage controller 108.a has ownership of the volume and storage controller 108.c has ownership of the mirror target in an initial state, leaving storage controllers 108.b and 108.d without any ownership responsibility for the volume of this example.

At time t1, storage controller 108.d fails. As ownership of the volume or the minor target does not rest with storage controller 108.d, this has no impact on the performance of the high availability pair for write-back caching of I/O requests to the volume.

At time t2, after the storage controller 108.d has already failed (and has not been replaced yet), the storage controller 108.b fails. Since the storage controller 108.b in this example does not have ownership of the volume or the minor target, its failure does not have an impact on performance of the high availability pair for write-back caching of I/O requests to the volume.

At time t3, after the storage controllers 108.b and 108.d have already failed (and not replaced yet), the storage controller 108.a fails. This is the owner of the volume, and therefore write-back caching is interrupted. As the mirror target, volume ownership transitions to the storage controller 108.c. Write-back caching is not available in this degraded mode, because there are no other storage controllers 108 to form a pair with. Write-back caching may resume, however, once any one or more of the failed storage controllers 108.a, 108.b, and 108.d in this example are replaced/repaired/become available again/etc.

FIG. 4B is another organizational chart 425 illustrating alternative high availability scenarios according to aspects of the present disclosure dealing with failures that impact a mirror target. The organizational chart 425 continues with the exemplary system 302 and storage controllers 108.a, 108.b, 108.c, and 108.d.

At time t0, in the initial state storage controller 108.a has ownership of the volume and storage controller 108.c has ownership of the mirror target, as in the example of FIG. 4A at time t0.

At time t1, the storage controller 108.c fails. Since storage controller 108.c is the owner of the mirror target, a new mirror target is selected. The owner of the volume, storage controller 108.a, may select the new mirror target from among the other available storage controllers 108.b and 108.d. In this example, the storage controller 108.a selects storage controller 108.d as owner for the mirror target (e.g., based on balancing and distribution targets/current information for each controller). The storage controller 108.a may copy its cache associated with the volume to recreate the mirror target at the selected storage controller 108.d, upon which write-back caching may again resume with high availability again established. Alternatively, the storage controller 108.a may flush its cache and continue with write-back caching with new I/Os with the new mirror target. Discussion herein will use the cache copy alternative for the examples.

At time t2, after storage controller 108.c has already failed, storage controller 108.d fails. Since storage controller 108.d was selected as the new mirror target at time t1, it is owner of the mirror target at time t2 when it fails. Thus, the storage controller 108.a, as owner of the volume, proceeds with selecting a new mirror target owner. Since two of the four controllers are now failed, the storage controller 108.a selects storage controller 108.b as owner of the mirror target. The storage controller 108.a may copy its cache associated with the volume to recreate the mirror target at the selected storage controller 108.b, upon which write-back caching may again resume with high availability again established.

At time t3, the storage controller 108.a fails. This is the owner of the volume, and therefore write-back caching is interrupted. As the mirror target owner, volume ownership transitions to the storage controller 108.b. Write-back caching may not available in this degraded mode, because there are no other storage controllers 108 to form a pair with (though, in some embodiments, other fallback mechanisms may be applied to temporarily support write-back caching until another storage controller 108 is available for pairing, such as mirroring to a nonvolatile memory, storage class memory, etc.). Write-back caching may resume, however, once any one or more of the failed storage controllers 108.a, 108.c, and 108.d in this example are replaced/repaired/become available again/etc.

FIG. 4C is an organizational chart 450 illustrating high availability scenarios according to aspects of the present disclosure dealing with failures that impact a volume owner. The organizational chart 450 continues with the exemplary system 302 and storage controllers 108.a, 108.b, 108.c, and 108.d.

At time t0, in the initial state storage controller 108.a has ownership of the volume and storage controller 108.c has ownership of the mirror target, as in the example of FIG. 4A at time t0.

At time t1, the storage controller 108.a fails. Since the storage controller 108.a is the owner of the volume in this example, a new volume owner is needed. In some embodiments of the present disclosure, the mirror target owner becomes the new volume owner since the relevant data is already at that storage controller. In an alternative embodiment illustrated in FIG. 4C, a different storage controller 108 becomes volume owner such that the mirror target owner remains the mirror target. For example, the storage controller 108.c, as mirror target owner, may select a new storage controller 108 to be volume owner from among the other available storage controllers 108.b and 108.d. In this example, the storage controller 108.c selects storage controller 108.b as owner for the volume (e.g., based on balancing and distribution targets/current information for each controller). The storage controller 108.c may copy its cache associated with the mirror target to recreate the volume at the selected storage controller 108.b, upon which write-back caching may again resume with high availability again established.

At time t2, after storage controller 108.a has failed, storage controller 108.b fails. Since storage controller 108.b was selected as the volume owner at time t1, it is owner of the volume at time t2 when it fails. Thus, the storage controller 108.c, as owner of the mirror target (in this example, continuing with the mirror target not becoming the new volume owner), proceeds with selecting a volume owner. Since two of the four controllers are now failed, the storage controller 108.c selects storage controller 108.d as owner of the volume. The storage controller 108.c may copy its cache associated with the mirror target to recreate the volume at the selected storage controller 108.d, upon which write-back caching may again resume with high availability again established.

At time t3, the storage controller 108.d fails. This is the owner of the volume, and therefore write-back caching is again interrupted. As the mirror target owner, volume ownership transitions to the storage controller 108.c. Write-back caching is not available in this degraded mode, because there are no other storage controllers 108 to form a pair with. Write-back caching may resume, however, once any one or more of the failed storage controllers 108.a, 108.b, and 108.d in this example are replaced/repaired/become available again/etc.

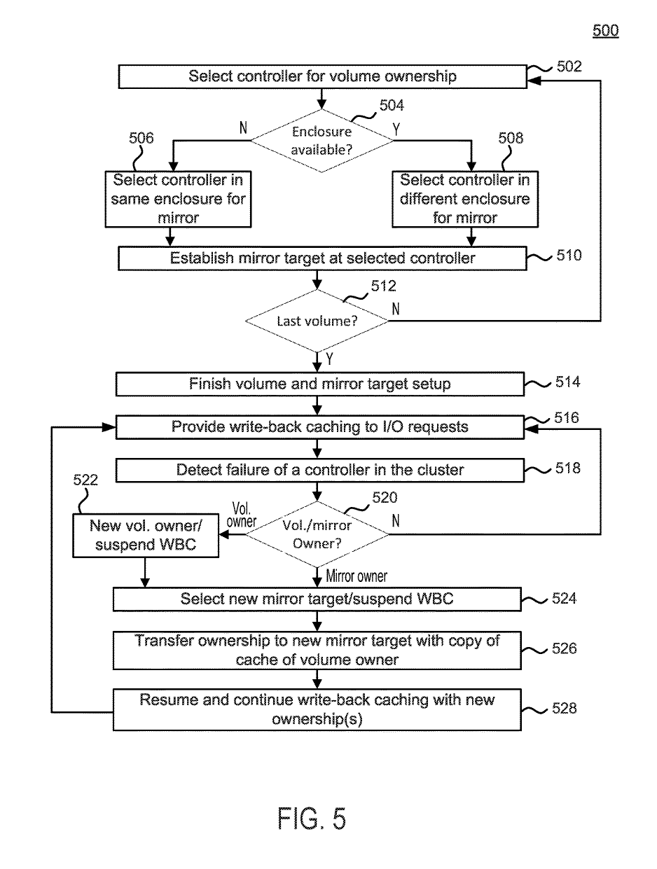

FIG. 5 is a flow diagram of a method 500 for maintaining consistent high availability and performance in view of storage controller failure according to aspects of the present disclosure. In an embodiment, the method 500 may be implemented by one or more processors of one or more of the storage controllers 108 of the storage system 102, executing computer-readable instructions to perform the functions described herein. In the description of FIG. 5, reference is made to a storage controller 108 (e.g., 108.a, 108.b, 108.c, 108.d) for simplicity of illustration, and it is understood that other storage controller(s) may be configured to perform the same functions when performing a pertinent requested operation. It is understood that additional steps can be provided before, during, and after the steps of method 500, and that some of the steps described can be replaced or eliminated for other embodiments of the method 500.

At block 502, a first storage controller 108 is selected for volume ownership. This may occur, for example, at an initial time when the volume is being instantiated by the system, or during a controller reboot to name some examples.

At decision block 504, the first storage controller 108 determines whether there are one or more storage controllers 108 available in a different storage enclosure (e.g., enclosure 103 from FIGS. 1 and 2) from the enclosure the first storage controller 108 is located. According to embodiments of the present disclosure, there may be three or more storage controllers 108 available to select from. Thus, the mirror targets in the present disclosure are selected on a per-volume basis. If another storage controller 108 in another enclosure is not available, then the method 500 proceeds to block 506.

At block 506, the first storage controller 108 selects a second storage controller 108 in the same enclosure, such as illustrated in FIG. 1, as an owner for the mirror target to the volume.

Returning to decision block 504, if another enclosure is available, then the method 500 proceeds to block 508. At block 508, the first storage controller 108 selects a second storage controller 108 in a different enclosure, such as controllers 108.c or 108.d where the first controller is controller 108.a from the examples of FIGS. 1 and 2.

From either blocks 506 or 508, the method 500 proceeds to block 510. At block 510, the first storage controller 108 establishes the mirror target at the selected second storage controller 108.

At decision block 512, it is determined whether the volume/mirror target just established was the last. If not (e.g., there are more volumes to instantiate), then the method 500 returns to block 502 for the next volume. If it was the last, then the method 500 proceeds to block 514.

At block 514, the first and second storage controllers 108 complete volume and mirror target setup.

At block 516, the first and second storage controllers 108 provide write-back caching to one or more host I/O requests in a high-availability manner. This includes, for example, a write directed toward a volume owned by the first storage controller 108 being mirrored to the second storage controller 108 as the mirror target. Once the write is mirrored (e.g., stored in a cache of the second storage controller 108), a status confirmation is sent back to the requesting host. After this occurs, the first and second storage controllers 108 may continue with persisting the write data to the targeted volume and mirror target (respectively). Similar operations may occur with respect to the second storage controller 108 and the first storage controller 108 for write operations directed to a volume owned by the second storage controller 108.

At block 518, a failure of a storage controller 108 is detected. For example, the remaining storage controllers 108 (e.g., one or more) may determine that a storage controller 108 has failed based on a communication timeout (no response within a period of time) and/or a heartbeat timeout. As noted with respect to the other figures above, failure may refer to any event that could lead to a storage controller becoming unavailable, whether due to physical or software/firmware issues.

At decision block 520, it is determined whether the failure was of a volume or mirror target owner. If not, then the method 500 returns to block 516 to continue servicing I/O requests with write-back caching, because the failure did not impact high availability of the volume.

If the failure was of the first storage controller 108, which was a volume owner, then the method 500 proceeds to block 522.

At block 522, write-back caching is momentarily suspended and a new volume owner is selected. In an embodiment, the second storage controller 108 may become the volume owner because it was already the owner of the mirror target. In that case, the method 500 proceeds to block 524 where a new mirror target owner is selected. In embodiments where the mirror target owner does not become volume owner, then the mirror target owner (here, second storage controller 108) may select the storage controller 108 to become the new volume owner from among the other storage controllers 108 still available.

Returning to decision block 520, if the failure was of the second storage controller 108, which was a mirror target owner, then the method 500 proceeds to block 524. At block 524, write-back caching is momentarily suspended and a new mirror target is selected. In an embodiment, the first storage controller 108 selects the mirror target owner (e.g., referred to here as a third storage controller 108) because the first storage controller 108 is volume owner.

With a third storage controller 108 selected as the new mirror target owner, at block 526 ownership of the mirror target is transferred to the third storage controller 108. This may include the first storage controller 108, as volume owner, copying its cache related to the volume and transferring that copy to the third storage controller 108.

At block 528, write-back caching resumes since the volume/mirror target high availability pair is re-established with new ownership of the volume and/or mirror targets. This is illustrated in FIG. 5, for example, by the method 500 returning to block 516 as discussed above, and proceeding according to method 500 should another failure occur.

As a result of the elements discussed above, a storage system's performance is improved by allowing high availability and high performance to continue/quickly resume in response to storage controller unavailability (e.g., device or software failure). Further, the impact on performance is reduced during controller firmware/hardware upgrades. Further, users of the storage system 102 may take advantage of embodiments of the present disclosure at little additional hardware cost (e.g., placing storage controllers in place of ESMs in storage enclosures).

In some embodiments, the computing system is programmable and is programmed to execute processes including the processes of method 500 discussed herein. Accordingly, it is understood that any operation of the computing system according to the aspects of the present disclosure may be implemented by the computing system using corresponding instructions stored on or in a non-transitory computer readable medium accessible by the processing system. For the purposes of this description, a tangible computer-usable or computer-readable medium can be any apparatus that can store the program for use by or in connection with the instruction execution system, apparatus, or device. The medium may include for example non-volatile memory including magnetic storage, solid-state storage, optical storage, cache memory, and Random Access Memory (RAM).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
providing, by a first storage controller within a storage controller cluster, write-back caching of an input/output (I/O) request, wherein the storage controller cluster distributes ownership of a plurality of volumes and a plurality of mirror targets on a per-volume basis, and wherein each one of the mirror targets corresponds to a respective one of the volumes;
detecting, by the first storage controller, a failure of a second storage controller within the storage controller cluster; and
providing, in response to detecting the failure by the first storage controller, write-back caching with a third storage controller within the storage controller cluster for a further I/O request after the failure of the second storage controller.

2. The method of claim 1, further comprising:
selecting, prior to the failure, the first storage controller as an owner of a first volume from among the plurality of volumes, wherein the first controller and the second controller are associated with a first storage enclosure; and
selecting, prior to the failure, the third storage controller as an owner of a first mirror target to the first volume, wherein the third controller is associated with a second storage enclosure different from the first storage enclosure.

3. The method of claim 2, wherein:
the storage cluster system comprises the first and second storage enclosures, the second storage enclosure further comprising a fourth storage controller, and
volume ownership and mirror targets are distributed so that corresponding volumes and mirror targets are initially not associated with a same storage enclosure.

4. The method of claim 1, wherein the second storage controller is unassociated with the plurality of volumes and the plurality of mirror targets, the method further comprising:
maintaining the ownership of the plurality of volumes and the plurality of mirror targets without change upon the detecting of the failure of the second storage controller.

5. The method of claim 1, wherein the second storage controller has ownership of at least one volume from among the plurality of volumes and the first storage controller has ownership of at least one corresponding mirror target, the method further comprising:
assuming, upon the detecting the failure of the second storage controller, ownership of the at least one volume by the first storage controller; and
selecting the third storage controller for ownership of the at least one mirror target for the at least one volume.

6. The method of claim 5, further comprising:
transferring ownership of the at least one mirror target to the selected third storage controller; and
suspending, during the transferring, write-back caching until the transferring is complete.

7. The method of claim 1, wherein the second storage controller has ownership of at least one mirror target from among the plurality of mirror targets and the first storage controller has ownership of at least one corresponding volume, the method further comprising:
selecting, upon detecting the failure of the second storage controller, the third storage controller to assume ownership of the at least one mirror target; and
copying a cache of the first storage controller to the third storage controller to re-create the at least one mirror target at the third storage controller.

8. A non-transitory machine readable medium having stored thereon instructions for performing a method comprising machine executable code which when executed by at least one machine, causes the machine to:
provide, by the machine comprising a first storage controller within a storage controller cluster, write-back caching to an input/output (I/O) request, wherein the storage controller cluster distributes ownership of a plurality of volumes and a plurality of mirror targets on a per-volume basis, and wherein each one of the mirror targets corresponds to a respective one of the volumes;
detect, by the first storage controller, a failure of a second storage controller within the storage controller cluster; and
provide, in response to the detection by the first storage controller, write-back caching with a third storage controller within the storage controller cluster for a further I/O request after the failure of the second storage controller.

9. The non-transitory machine readable medium of claim 8, further comprising machine executable code that causes the machine to:
select, prior to the failure, the first storage controller as an owner of a first volume from among the plurality of volumes, wherein the first controller and the second controller are associated with a first storage enclosure; and
select, prior to the failure, the third storage controller as an owner of a first mirror target to the first volume, wherein the third controller is associated with a second storage enclosure different from the first storage enclosure.

10. The non-transitory machine readable medium of claim 9, wherein:
the machine comprises the first and second storage enclosures, the second storage enclosure further comprising a fourth storage controller, and
volume ownership and mirror targets are distributed so that corresponding volumes and mirror targets are initially not associated with a same storage enclosure.

11. The non-transitory machine readable medium of claim 8, wherein the second storage controller is unassociated with the plurality of volumes and the plurality of mirror targets, further comprising machine executable code that causes the machine to:
maintain the ownership of the plurality of volumes and the plurality of mirror targets without change upon detection of the failure of the second storage controller.

12. The non-transitory machine readable medium of claim 8, wherein the second storage controller has ownership of at least one volume from among the plurality of volumes and the first storage controller has ownership of at least one corresponding mirror target, further comprising machine executable code that causes the machine to:
assume, upon detection of the failure of the second storage controller, ownership of the at least one volume by the first storage controller; and
select the third storage controller for ownership of the at least one mirror target for the at least one volume.

13. The non-transitory machine readable medium of claim 12, further comprising machine executable code that causes the machine to:
transfer ownership of the at least one mirror target to the selected third storage controller; and
suspend, during the transfer, write-back caching until the transfer is complete.

14. The non-transitory machine readable medium of claim 8, wherein the second storage controller has ownership of at least one mirror target from among the plurality of mirror targets and the first storage controller has ownership of at least one corresponding volume, further comprising machine executable code that causes the machine to:
select, upon detection of the failure of the second storage controller, the third storage controller to assume ownership of the at least one mirror target; and
copy a cache of the first storage controller to the third storage controller to re-create the at least one mirror target at the third storage controller.

15. A computing device comprising:
a memory containing machine readable medium comprising machine executable code having stored thereon instructions for performing a method of maintaining high availability in a storage controller cluster comprising the computing device, the computing device comprising a first storage controller; and
a processor coupled to the memory, the processor configured to execute the machine executable code to cause the processor to:
provide write-back caching to an input/output (I/O) request, wherein ownership of a plurality ofvolumes and a plurality of mirror targets is distributed among at least three storage controllers including the first storage controller on a per-volume basis, and wherein each one of the mirror targets corresponds to a respective one of the volumes;
detect a failure of a second storage controller from among the at least three storage controllers within the storage controller cluster; and
provide, in response to the detection of the failure, write-back caching with a third storage controller within the storage controller cluster for a further I/O request after the failure of the second storage controller.

16. The computing device of claim 15, the machine executable code further causing the processor to:
select, prior to the failure, the first storage controller as an owner of a first volume from among the plurality of volumes, wherein the first controller and the second controller are associated with a first storage enclosure of the computing device; and
select, prior to the failure, the third storage controller as an owner of a first mirror target to the first volume, wherein the third controller is associated with a second storage enclosure different from the first storage enclosure of the computing device.

17. The computing device of claim 15, wherein the second storage controller is unassociated with the plurality of volumes and the plurality of mirror targets, the machine executable code further causing the processor to:
maintain the ownership of the plurality of volumes and the plurality of mirror targets without change upon detection of the failure of the second storage controller.

18. The computing device of claim 15, wherein the second storage controller has ownership of at least one volume from among the plurality of volumes and the first storage controller has ownership of at least one corresponding mirror target, the machine executable code further causing the processor to:
assume, upon detection of the failure of the second storage controller, ownership of the at least one volume by the first storage controller; and
select the third storage controller for ownership of the at least one mirror target for the at least one volume.

19. The computing device of claim 18, the machine executable code further causing the processor to:
transfer ownership of the at least one mirror target to the selected third storage controller; and
suspend, during the transfer, write-back caching until the transfer is complete.

20. The computing device of claim 15, wherein the second storage controller has ownership of at least one mirror target from among the plurality of mirror targets and the first storage controller has ownership of at least one corresponding volume, the machine executable code further causing the processor to:
select, upon detection of the failure of the second storage controller, the third storage controller to assume ownership of the at least one mirror target; and
copy a cache of the first storage controller to the third storage controller to re-create the at least one mirror target at the third storage controller.
